(19) United States
(12) Patent Application Publication
(10) Pub. No.: US 2026/0228333 A1
(43) Pub. Date: Aug. 6, 2026

(54) RISK AWARE FILTERING FOR INDIRECT PROMPT INJECTION ATTACK DETECTION ACROSS AI SAAS INTEGRATIONS

(71) Applicant: Palo Alto Networks, Inc., Santa Clara, CA (US)

(72) Inventors: Nikhil Garg, Gurugram (IN); Anurag Singhal, Dwarka (IN); Mayank Bhatnagar, Bangalore (IN)

(21) Appl. No.: 19/041,230

(22) Filed: Jan. 30, 2025

(51) Int. Cl. G06F 21/56

(52) U.S. Cl. CPC G06F 21/566; G06F 2221/033

(57) ABSTRACT

A framework has been created to filter queries for prompt injection attack detection. Application connectors collect data of SaaS interactions. The connectors associate, with the collected data, metadata that identifies the third-party application integrated with a primary SaaS application and an indication of whether collected data is sourced from an external user or an internal user. The filtering service periodically obtains a list of applications and risk scores and determines a risk score of the third-party application with the list. If the risk exceeds a threshold and/or the data origin is indicated as an external user, then the filtering service submits the data to a prompt injection attack detection service. Otherwise, the filtering service filters out the data from being submitted to the prompt injection attack detection service.

### BACKGROUND

The disclosure generally relates to cybersecurity and digital data processing (e.g., CPC subclass G06F 11 and CPC subclass H04L 67/00).

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the "Transformer" architecture.

A "Transformer" was introduced in VASWANI, et al. "Attention is all you need" presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a "foundational model." The Center for Research on Foundation Models at the Stanford Institute for Human-Centered Artificial Intelligence used this term in an article "On the Opportunities and Risks of Foundation Models" to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data.

Some LLMs are based on the Transformer architecture. An LLM is "large" because the training parameters are typically in the billions and trillions. AI technologies are not limited to LLMs and research and utilization of "lightweight" language models (i.e., fewer parameters than large) has grown. Language models can be pre-trained to perform general-purpose tasks or tailored to perform specific tasks. Tailoring of language models can be achieved through various techniques, such as prompt engineering and fine- tuning.

Application integration refers to the integration of applications that allows sharing of data and coordinating performance of sub-tasks to complete a task. In a Software-as-a-Service context, a SaaS integration is an integration of multiple SaaS applications. Integrating SaaS applications facilitates efficient development with component reuse and creation of complex, automated workflows. The rapid developments in AI and introduction of foundation models into SaaS applications has amplified the number of SaaS integrations being regularly created and injects existing AI capabilities into these complex, automated workflows.

The growth in generative AI has been accompanied by abuse and exploitation to attack applications that use generative AI. Malicious actors have been maliciously manipulating prompts (i.e., the input to a generative AI model). At this time, malicious prompt manipulation is also referred to as prompt hacking. Categories of existing prompt hacking are prompt injection (including direct and indirect prompt injection), prompt leaking, and jailbreaking. Although the terms prompt injection and prompt hijacking are often informally used to refer to any type of prompt manipulation that abuses a generative AI model or foundation model, the use is imprecise. Similar to a SQL injection attack, prompt injection attacks mix benign task instructions with malicious task instructions in a prompt. It is uncertain whether a generative AI model can discern malicious task instructions in a prompt, but likely it cannot and may lack in certain detection capabilities. Thus, SaaS integrations that include an AI based SaaS application can be vulnerable to prompt injection attacks.

### BRIEF DESCRIPTION OF THE DRAWINGS

Embodiments of the disclosure may be better understood by referencing the accompanying drawings.

FIG. 1 depicts a system that intelligently filters application layer messages communicated among integrated SaaS applications to selectively query a prompt attack injection attack service.

FIG. 2 is a flowchart of example operations for interaction between a SaaS application connector and a prompt injection attack detection filtering service.

FIG. 3 is a flowchart of example operations for selectively analyzing fetched artificial intelligence (AI) application traffic data for prompt injection attack detection.

FIG. 4 is a flowchart of example operations for processing a response from the prompt injection attack detection service.

FIG. 5 depicts an example computer system with program code for a prompt injection attack detection filtering service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Software-as-a-Service (SaaS) integrations have grown immensely and rapidly as evidenced by the numerous application marketplaces available for SaaS applications. A marketplace for a popular SaaS application can easily offer thousands of other applications for integrations. Deployments of applications via a marketplace likely do not adhere to best security practices, such as a zero trust approach. A SaaS application may not enforce strict control on read and write permissions granted to applications in the marketplace. Moreover, the applications deployed in marketplaces may be created by malicious actors. While API security solutions attempt to address the multiplying threat vectors from these integrations, the introduction of LLM-powered/LLM-based applications into these integrations ("AI SaaS integrations") creates additional threat vectors, such as prompt injection attacks. While detection services have been created to detect prompt injection attacks, these detection services would be overwhelmed by the volume of data flowing among the components of AI SaaS integrations or incur a significant expense to scale up the detection service(s) to perform detection at the magnitude of data yielded from AI SaaS integrations transactions.

A framework has been created with a filtering service to intelligently select data for prompt injection attack detection. Application connectors collect data of numerous interactions among applications in SaaS interactions. The connectors associate, with the collected data, metadata that identifies the third-party application integrated with a primary SaaS application and an indication of whether collected data is sourced from an external user or an internal user with respect to a tenant associated with the SaaS application. The filtering service frequently obtains a list of applications and risk scores and determines a risk score of the third-party application with the list. If the risk exceeds a threshold and/or the data origin is indicated as an external user, then the filtering service submits the data to a prompt injection attack detection service. Otherwise, the filtering service filters out the data from being submitted to the prompt injection attack detection service. A security action can be performed based on a verdict of the prompt injection attack detection service or additional insight from another cybersecurity service based on the verdict.

### Example Illustrations

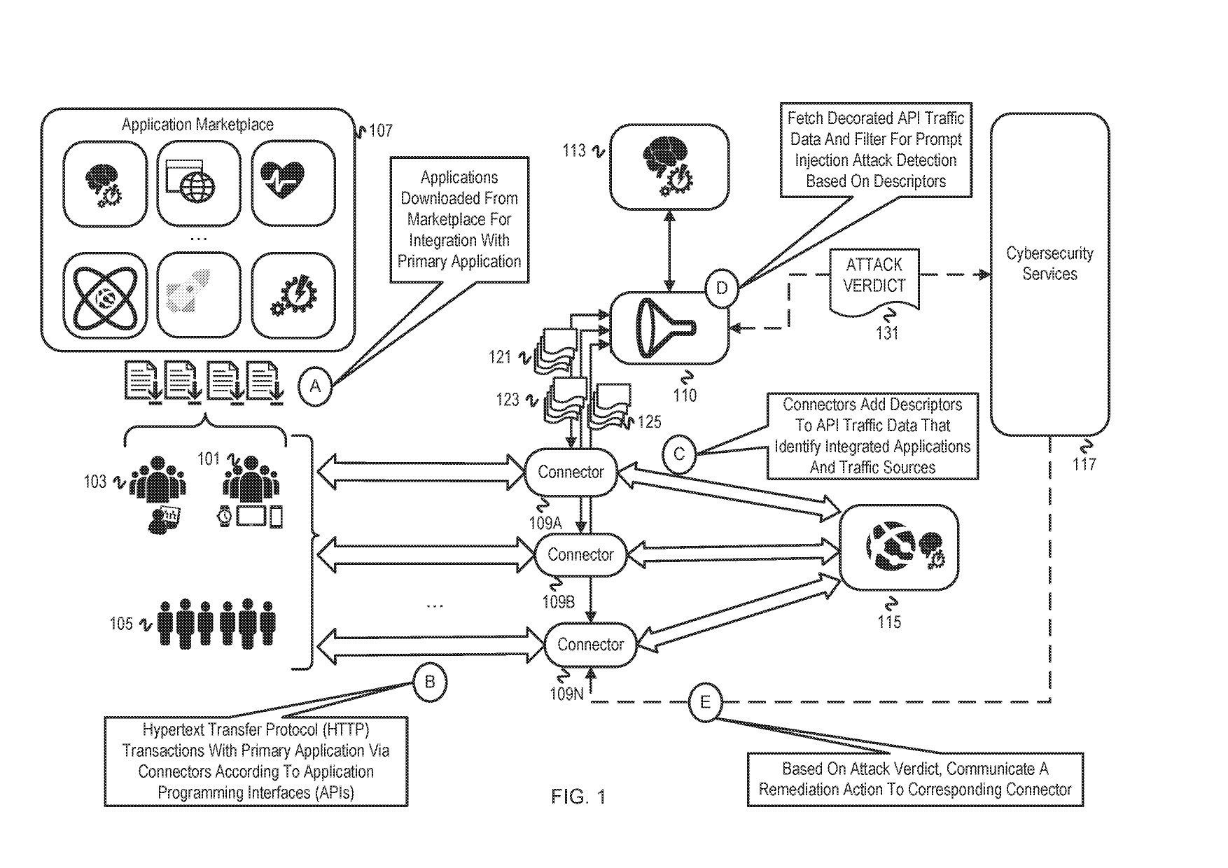

FIG. 1 depicts a system that intelligently filters application layer messages communicated among integrated SaaS applications to selectively query a prompt attack injection attack service. The system is based on a framework that inserts a filtering service 110 among a prompt injection attack detection service 113, cybersecurity services 117, and application connectors 109A - 109N. The cybersecurity services 117 can include a cloud access security broker, a cloud security policy manager, data leakage prevention, malware detection, ransomware detection, etc. The prompt injection attack detection service 113 is a foundation model or artificial intelligence based service that analyzes text to determine whether it corresponds to a prompt injection attack.

Each of the application connectors 109A - 109N is an intermediary between APIs of integrated applications. FIG. 1 depicts a marketplace 107 of applications that can integrate with a SaaS application 115. The SaaS application 115 is depicted as a large language model (LLM) based SaaS application. In some cases, the application being integrated with the application 115 is a LLM based application. Application connectors that do not implement an API for at least one LLM based application would not interact with the filtering service 110. Thus, this disclosure only refers to application connectors that implement an API for at least one LLM based application. To illustrate, assume the application connector 109A is a connector for one of the applications in the marketplace that is a non-LLM based plug-in for the application 115. The application connector 109A would receive API request or response messages from the plug-in and map to API request/response messages for the API of the application 115. In addition to being an intermediary of APIs, each of the application connectors 109A - 109N has been configured/programmed to interact with the filtering service 110. For instance, each of the application connectors 109A-109N is configured/programmed to submit hypertext transfer protocol (HTTP) requests according to an API of the filtering service 110 with payloads of the API messages traversing the connector.

FIG. 1 is annotated with a series of letters A - E, each of which represents a stage of one or more operations. Although these stages are ordered for this example, the stages illustrate one example to aid in understanding this disclosure and should not be used to limit the claims. For instance, the illustrated stages of operations represent multiple transactions across multiple SaaS integrations which will occur asynchronously with respect to each other. Subject matter falling within the scope of the claims can vary from what is illustrated.

At stage A, various users download various ones of the applications offered in the application marketplace 107 for integration with the application 115. The application 115 is referred to as the "primary" application merely to differentiate from the various applications of the marketplace 107. FIG. 1 differentiates among the users and devices as internal users 101, 103 and external users 105. The internal users 101, 103 are internal with respect to a tenant (i.e., users defined for an organization that uses the application 115). The external users 105 are not defined members or users of the organization. The internal users 103 represent users that download a marketplace applications to a managed device (i.e., a device managed by the organization). The internal users 101 represent users that download marketplace applications to unmanaged devices or bring your own device (BYOD) devices. While referred to as internal users, any one of the internal users 101, 103 may be onsite (i.e., within a secured network of the organization) or remote when accessing a SaaS integration that includes the application 115.

At stage B, instances of the various marketplace applications integrated with the application 115 interact with the application 115 via corresponding ones of the application connectors 109A - 109N. The various integrations correspond to devices of the users 101, 103, 105. The interactions, for example, are embodied as HTTP transactions with requests and responses conforming to the relevant APIs. Each of the requests and responses will include a payload that may include a prompt to be submitted to a LLM based application, such as the application 115, or a response from a LLM.

At stage C, the application connectors 109A - 109N decorate application layer messages or payloads of the application layer messages (e.g., HTTP request body) with descriptors for the API traffic data. As an intermediary, the application connectors 109A - 109N will be endpoints for secure communication connections with the integrated applications. Thus, the application connectors 109A - 109N will have access to the decrypted payloads. This description refers to the requests and payloads of the requests as API traffic data. The application connectors 109A - 109N add descriptors/metadata to the API traffic data without modifying the API traffic data ("decorate"). The application connectors 109A-109N decorate the API traffic data with metadata that describes ("descriptors") a corresponding application and a user perspective source (e.g., internal versus external). API traffic data from a managed device, which implies an internal user, will already be secured by other cybersecurity components of the organization. A user perspective source that is either an external user or an unmanaged device will not have that protection. The application connectors 109A - 109N will decorate the API traffic data with values for the user perspective source. The application connectors 109A - 109N will also decorate the API traffic data with an identifier of the marketplace application. The application connector 109A will decorate API traffic data of its SaaS integration. Likewise, the application connectors 109B, 109N will decorate API traffic of their respective SaaS integrations.

At stage D, the filtering service 110 fetches decorated API traffic data from the connectors 109A, 109B, 109N and filters the API traffic data based on the descriptors of the API traffic data. According to a defined security policy, the filtering service 110 filters out API traffic data with a descriptor indicating an internal user source. Instead of querying the prompt injection attack detection service 113 (hereinafter "detection service"), the filtering service 110 can either explicitly respond to an application connector that the corresponding message be allowed to pass or indicate that the request for the detection service was filtered out. For externally sourced API traffic data, the filtering service 110 determines a risk score of the marketplace application and filters out requests corresponding to API traffic data of an application that has low risk. For externally sourced API traffic data of risky applications, the filtering service 110 will query the detection service 113. If the response from the detection service 113 is that a prompt injection attack is not detected, then the filtering service 110 does not perform a security action to block the corresponding traffic. If the detection service 113 responds with a verdict that a prompt injection attack was detected in a message, the filtering service 110 can perform or initiate a security action. For example, the filtering service 110 can instruct the corresponding one of the application connectors 109A - 109N to block a response to the message and/or can convey the API traffic data and an attack verdict 131 to one or more of the cybersecurity services 117.

At stage E (depicted as optional with a dashed line), one or more of the cybersecurity services 117 communicates a remediation action to a corresponding one of the application connectors 109A - 109N. When forwarding to one of the cybersecurity services 117, the filtering service would forward the API traffic data, descriptors, and information to correctly route the remediation action (e.g., a connector identifier). The remediation action can instruct a connector to block corresponding traffic, sandbox the corresponding traffic, generate a notification to a user, etc. In some cases, the cybersecurity services 117 can implement a remediation action by communicating with the application 115 and/or with a managed device of the users 103.

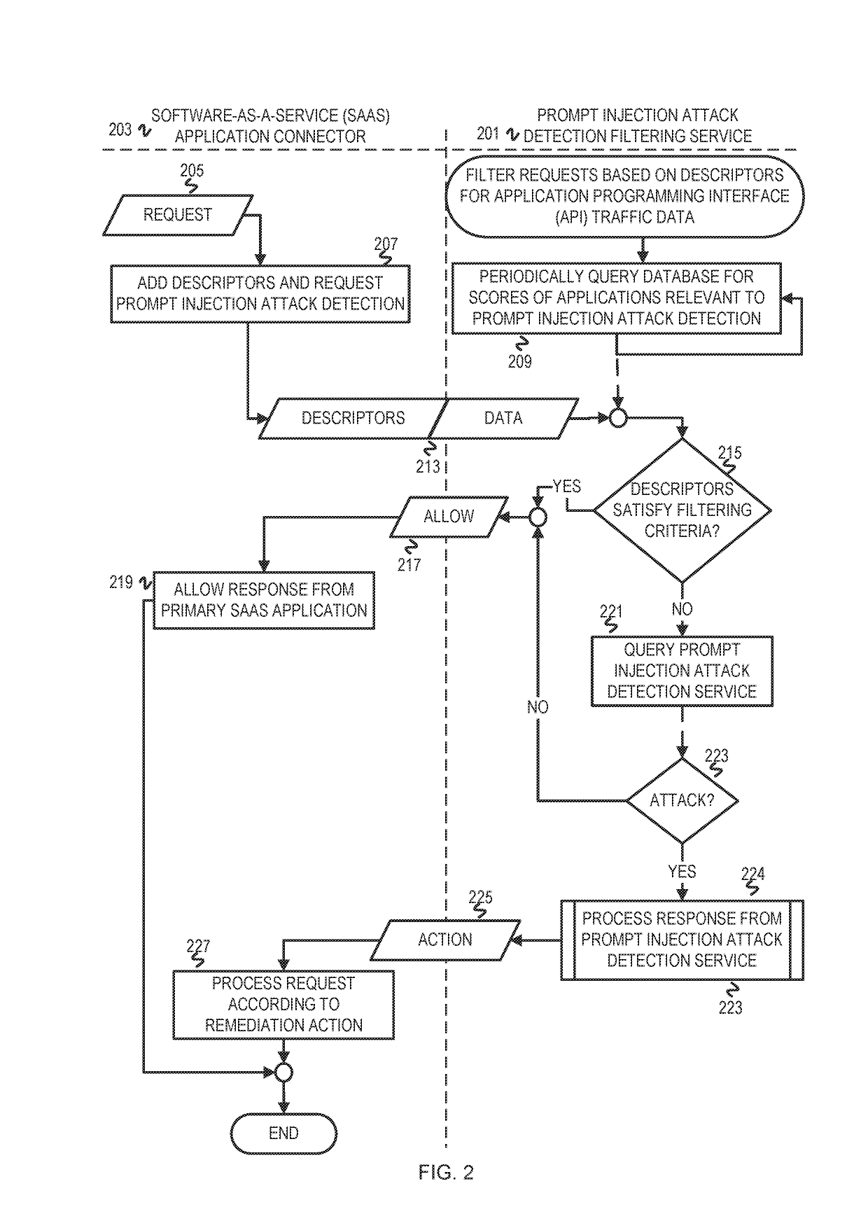

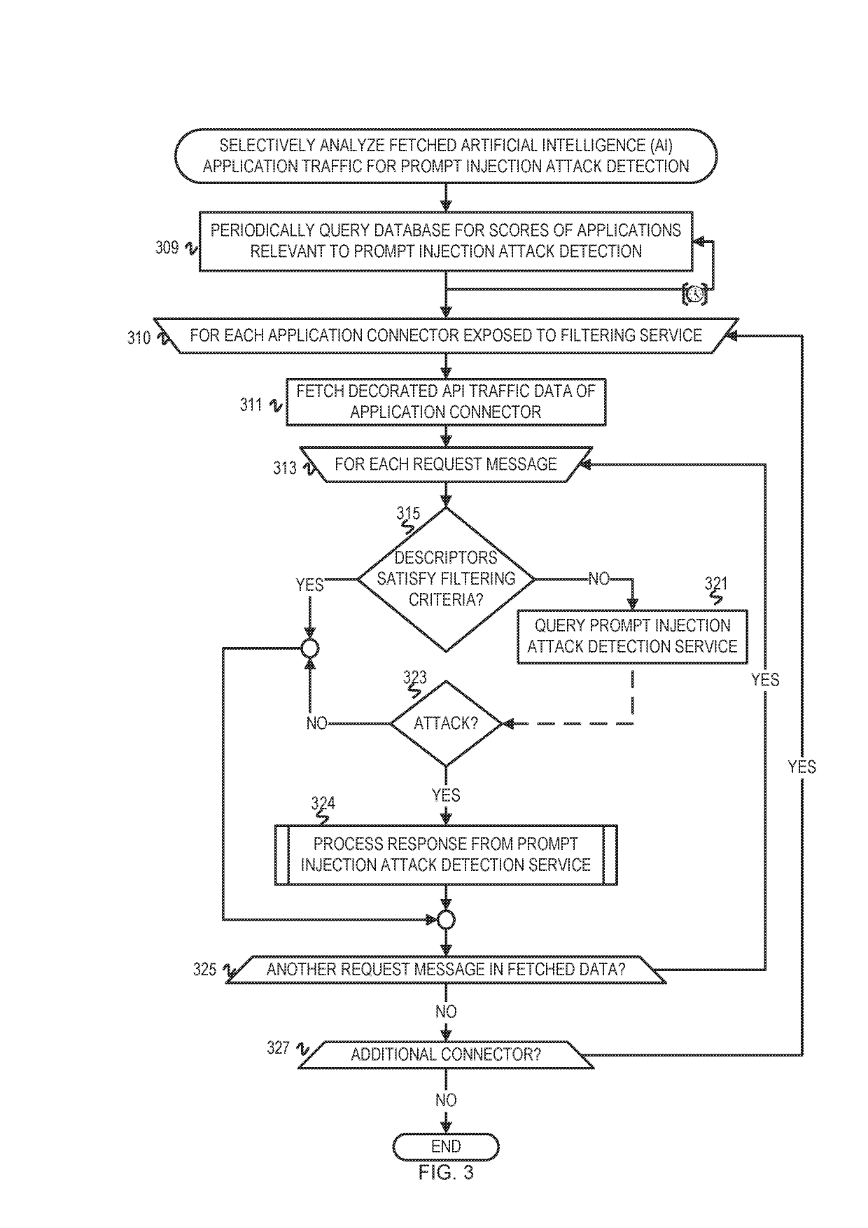

FIGS. 2 and 3 are flowcharts for different embodiments relating to the interactions between application connectors and the filtering service. FIG. 2 corresponds to an embodiment in which the connectors submit decorated API traffic data to a filtering service. FIG. 3 corresponds to an embodiment in which the filtering service fetches decorated API traffic data from application connectors. FIG. 2 is a flowchart of example operations for interaction between a SaaS application connector and a prompt injection attack detection filtering service. The example operations of a SaaS application connector 203 involve adding descriptors and operations related to requesting prompt injection attack detection. The example operations of a prompt injection attack detection filtering service 201 ("filtering service") in FIG. 2 are for filtering requests based on descriptors for API traffic data. As previously mentioned, API traffic data can be a request message or content/payload of a request message depending upon implementation.

At block 207, the SaaS application connector 203 adds descriptors to a received request message 205 and requests prompt injection attack detection. The SaaS application connector 203 receives the API message 205 (e.g., a request or response message that conforms to an API of a SaaS application) from one of the SaaS applications connected by the SaaS application connector 203. The request 205 may carry a prompt to be delivered to a LLM. The SaaS application connector 203 determines whether the request 205 is from an external user or internal user. The SaaS application connector 203 can make this determination based on information of the HTTP session carrying the API message and configuration information previously obtained from a SaaS administrator. Examples of this information can include trusted and/or untrusted domains and subnets corresponding to an organizations' networks. For example, a request with a source network address within an organization's network will be indicated as internal and a request indicating a domain that has not been specified as trusted will be characterized as external (e.g., user5(externalexample.com would be external to a trusted domain example.com). In addition, the SaaS application connector 203 will add a descriptor that identifies the application that generated the request 205. As the SaaS application connector 203 implements APIs of connected applications, the SaaS application connector 203 will have stored locally an application identifier (e.g., application name, application signature, etc.). The SaaS application connector 203 decorates API traffic data (indicated only as data in FIG. 2 due to space constraints) corresponding to the request 205 (e.g., the request 205 or payload of the request 205) and generates a request 213 that includes the descriptors and API traffic data. Examples of the data that a SaaS application connector can collect and use to decorate API traffic data include data indicating login, file sharing, whether a request is for uploading or downloading, whether the request is creating an account or user, document sharing, etc. The SaaS application connector 203 communicates the request 213 to the filtering service 201.

At block 209, the filtering service 201 periodically queries a database of application scores for scores of applications relevant to prompt injection attack detection. In other implementations, the filtering service 201 periodically refreshes a cached list of application scores. When initialized, the filtering service 201 retrieves a list of applications and application scores. The filtering service 201 refreshes the list at a configured time interval. To retrieve and refresh the list, the filtering service 201 can query a catalog of supported applications or applications having corresponding application connectors. The list can be limited to either marketplace applications that are AI applications or AI applications with applications in marketplaces. The filtering service 201 can obtain application scores by processing one or more feeds of application scores..

At block 215, the filtering service 201 receives the request 213 and determines whether the descriptors added to the API traffic data satisfy filtering criteria. The filtering service 201 receives query requests from numerous application connectors. Accordingly, the filtering service 201 will maintain data to track state of requests across application connectors. For instance, the filtering service 201 can maintain a receive buffer for each application connector for received requests not yet processed and an in-flight buffer for each application connector for requests that have been submitted to the prompt injection attack detection service. As another example, the filtering service 201 can maintain a mapping structure (in addition or instead of buffers) that maps message identifiers (e.g., network flow identifiers, application identifier, message content hash, etc.) to application connector sessions. The filtering service 201 can then use the mapping structure to determine a destination application connector when a verdict is received from the prompt injection attack detection service. As previously mentioned, API traffic data from internal users have a low likelihood of carrying a prompt injection attack and have other protection measures. While a filtering service may not filter based on the user source descriptor, the filtering service 201 is presumed to be enforcing a security policy that focuses detection on requests from external users. For instance, the filtering service 201 will determine whether a user source indicated in the request 213 is on an allowed list or matches a domain of a SaaS. To illustrate, the request 205 is to a SaaS app.example.com. The filtering service will determine that a source attribute of the request 205 indicating <user>@app.example.com is an internal user perspective with respect to the SaaS. Thus, the filtering or filtering out criteria, in this example, indicate internal user and a risk score threshold. If the descriptors in the request 213 indicate internal user, then the filtering (out) criteria are satisfied, and the filtering service 201 sends an allow message 217 to the SaaS application connector 203. If the request 213 has a descriptor indicating external user source, then the filtering service 201 determines whether the risk score of the connected application is low. The filtering service 201 will look up the risk score by application identifier in the descriptor and evaluate the risk score against a threshold. In the case of multiple risk scores (e.g., a risk score for a plug-in and a risk score for a primary application), the filtering service 201 selects the highest risk score for evaluation. Assuming a scale of 1 - 5, the security policy may indicate that a risk score below 4 is low risk. If the risk score is low risk, then the filtering service 201 will communicate the allow message 217 to the SaaS application connector 203.

At block 219, the SaaS application connector 203 allows a response to the request 205 from the primary SaaS application - the primary SaaS application being the AI application of the SaaS integration. The filtering and communicating of requests is asynchronous. The request 205 will have been communicated to the primary SaaS application while the filtering service 201 filters and possibly obtains a verdict from the detection service. The allow message 217 will be communicated prior to a response.

At block 221, the filtering service has determined that the request 213 should not be filtered out and queries the detection service. The filtering service can form a request to the detection service that includes the API traffic data of the request 213 as content/payload. A dashed line from block 221 to block 223 represents the filtering service awaiting a response from the detection service.

At block 223, the filtering service determines whether the detection service returns a verdict indicating that a prompt injection attack was detected. If the verdict does not indicate that a prompt injection attack was detected, then the filtering service 201 sends the allow message 217 to the SaaS application connector 203. If the verdict indicates that a prompt injection attack was detected, then operational flow proceeds to block 224.

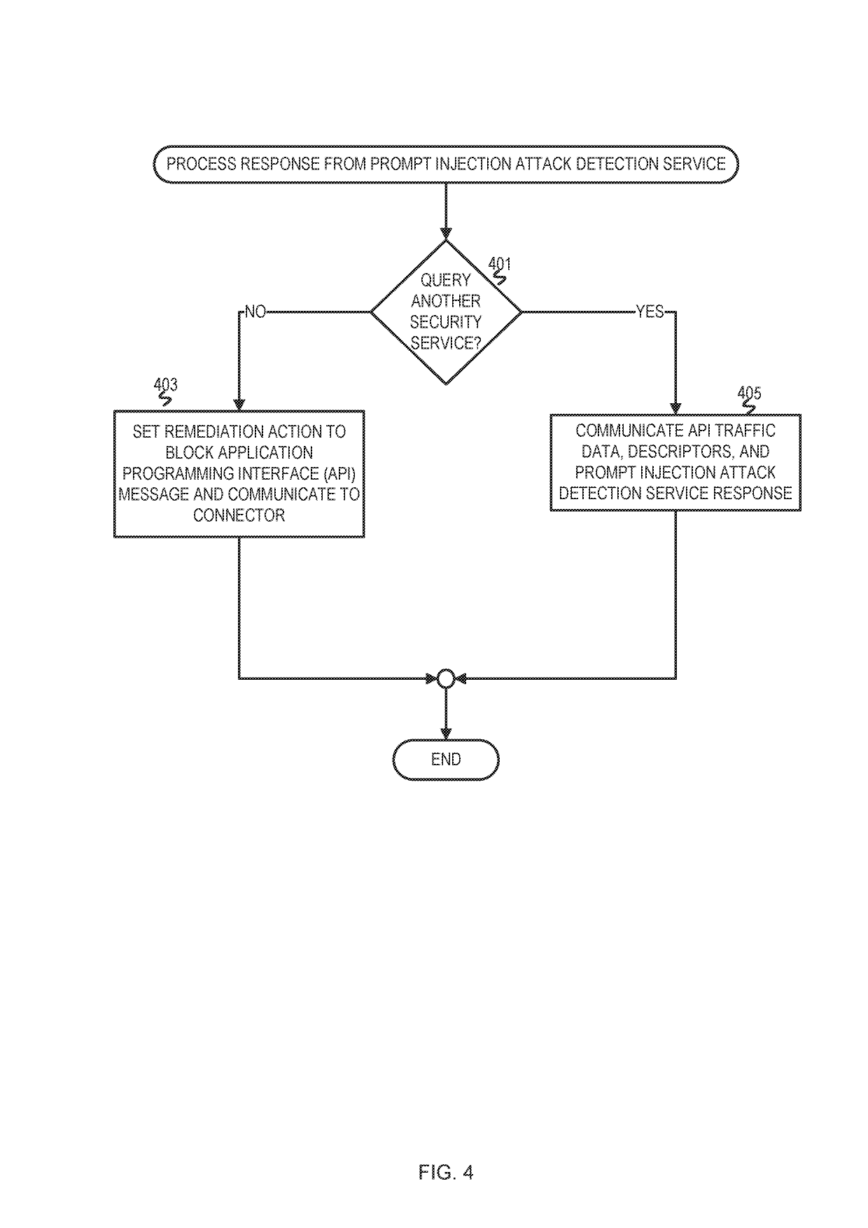

At block 224, the filtering service processes the response from the prompt injection attack detection service. FIG. 4 elaborates on the operations of block 224.

After processing the response from the detection service, a remediation action 225 is communicated to the SaaS application connector 203. The remediation action 225 may be communicated from the filtering service 201 or another cybersecurity service. At block 227, the SaaS application connector 203 processes the request 205 according to the remediation action 225. For example, the SaaS application connector 203 blocks the corresponding message, blocks all traffic in the same network traffic flow, generates a warning, etc.

FIG. 3 is a flowchart of example operations for selectively analyzing fetched artificial intelligence (AI) application traffic data for prompt injection attack detection. Similar to FIG. 2, the example operations perform filtering to reduce the demand on a prompt injection attack detection service without compromising cybersecurity effectiveness. In contrast to the example operations of FIG. 2, the example operations of FIG. 3 are based on implementations in which the application connectors write decorated API traffic data of AI applications to a repository or destination accessible to the filtering service. Of course, implementations can involve load balancing of multiple instances of a filtering service across a geographically dispersed infrastructure.

At block 309, the filtering service periodically queries a database of application scores for scores of applications relevant to prompt injection attack detection. This is similar to block 209 in FIG. 2. Information collected from security analysis sources and/or security professionals can be used to update the database of risk scores of applications, plug-ins/extensions, and/or application integrations.

At block 310, the filtering service begins processing each application connector exposed to the filtering service. The filtering service can iterate over a list of application connectors configured to provide decorated API traffic data to the filtering service. For example, an administrator of an AI application may configure the connector to write decorated application requests to a location that can be read by the filtering service. A timer can be set to trigger the filtering service to iterate over the list.

At block 311, the filtering service fetches decorated API traffic data of application connector. The application connector will have collected and decorated one or more application messages communicated to an AI application. The filtering service will fetch the data for evaluation.

At block 313, the filtering service begins to process each request message in the fetched API traffic data. Since the connector operates at the application layer, the collected API traffic data is at the application layer and comprises application layer messages, such as HTTP messages.

At block 315, the filtering service determines whether the descriptors added to the request message satisfy filtering criteria. API/application traffic from internal users have a low likelihood of carrying a prompt injection attack and have other protection measures. The filtering service determines whether the descriptors indicate the request message is from an external user or an internal user, where external and internal are dependent upon configuration of the application. As previously discussed, the configuration information can specify subnets and domains that indicate an internal user. If the request message is from an external user, then the filtering criteria is not satisfied because external users are presumed risky. If the request message is from an internal user, then the filtering service evaluates an application risk score associated with the request message. The filtering service looks up the risk score by application identifier in the descriptor and evaluates the risk score against a threshold. If the risk score exceeds the threshold, then the filtering criteria is not satisfied and operational flow proceeds to block 321. If the filtering criteria are satisfied, then operational flow proceeds to block 325.Of course, the filtering criteria can be implemented differently. Instead of the risk score evaluation being dependent upon the user being an external user, the filtering criteria may specify that the request message be filtered out from being submitted to the attack detection service if the risk score is high or the user is external, for example.

At block 321, the filtering service has determined that the request message should not be filtered out and queries the detection service. The filtering service can form a request to the detection service that includes the request message as content/payload. A dashed line from block 321 to block 323 represents the filtering service awaiting a response from the detection service.

At block 323, the filtering service determines whether the detection service returns a verdict indicating that a prompt injection attack was detected. If the verdict does not indicate that a prompt injection attack was detected, then operational flow proceeds to block 325. If the verdict indicates that a prompt injection attack was detected, then operational flow proceeds to block 324.

At block 324, the filtering service processes the response from the prompt injection attack detection service. FIG. 4 elaborates on the operations of block 324.

At block 325, the filtering service determines whether there is another request message in the fetched data. If there is another request message, then operational flow returns to block 313. Otherwise, operational flow proceeds to block 327.

At block 327, the filtering service determines whether there is another connector from which to fetch application traffic data. If so, then operational flow returns to block 310. Otherwise, operational flow ends for FIG. 3.

FIG. 4 is a flowchart of example operations for processing a response from the prompt injection attack detection service. This processing is within the context of the filtering service within a framework that filters requests from application connectors to avoid overwhelming the detection service. In experiments, queries for prompt injection attack detection for 25 applications integrated with a LLM based application was reduced to approximately 60 queries per second (qps) with the filtering. A detection service can have a capacity to process approximately 1000 qps. Thus, the filtering allows a detection service with this qps capacity to serve 10 AI SaaS applications each having 25 or more integrations and other clients of the detection service, such as firewalls, extended endpoint protection, etc. These example operations are performed when the prompt injection attack detection service detects a prompt injection attack in a message or message content.

At block 401, the filtering service determines whether another security service should be queried. In addition to informing the filtering, a security policy will be defined for the filtering service that indicates whether the filtering service should query another cybersecurity service when the prompt injection attack detection service returns an attack verdict (i.e., indicates that prompt injection attack is detected in message content). If the security policy indicates another cybersecurity is to be queried or provided the corresponding API traffic data, then operational flow proceeds to block 405. Otherwise, operational flow proceeds to block 403.

At block 403, the filtering service sets a remediation action to block the API message corresponding to the verdict. The filtering service returns a response to the query request from the SaaS application connector that indicates an attack was detected or that the message should be blocked. In some cases, the filtering service can communicate that all traffic from the source network address should be blocked or held.

At block 405, the filtering service communicates the API traffic data corresponding to the verdict from the detection service, descriptors of the API traffic data, and the prompt injection attack detection service response or verdict. This information can be conveyed to a cybersecurity platform or service(s) to allow detection of patterns and/or determination of a remediation action. For instance, a cybersecurity platform or service can analyze the network address or user information of the API traffic data to determine a remediation action, detect a campaign, etc.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a "circuit," "module" or "system." The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

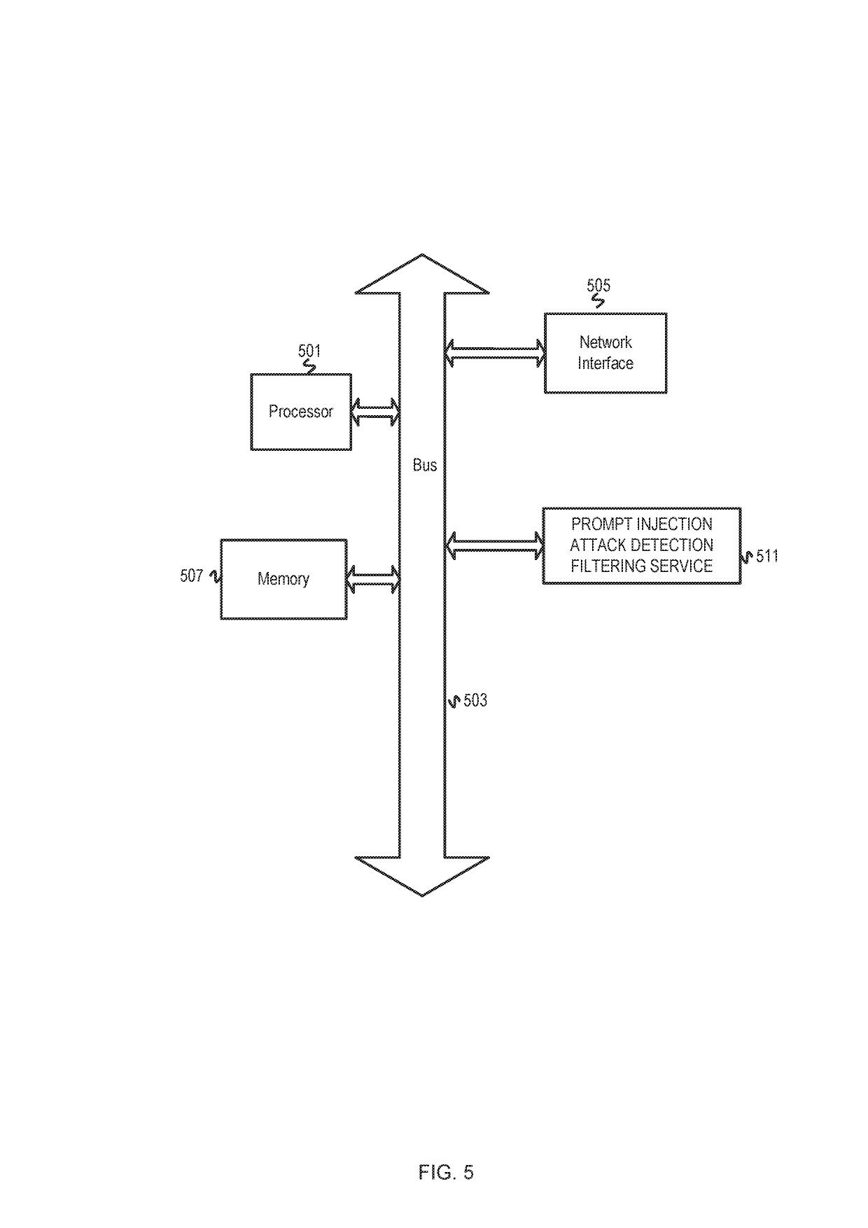

FIG. 5 depicts an example computer system with program code for a prompt injection attack detection filtering service. The computer system includes a processor 401 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes prompt injection attack detection filtering service 511. The filtering service 511 is deployed as part of a framework for filtering and remediating relative to model prompts and prompt injection attacks. The framework includes application connectors that decorate API traffic data with descriptors for attributes of the corresponding API request (e.g., application identifier and source attribute) that are used by the filtering service 511 to intelligently select from the query requests and reduce the volume of queries presented to a prompt injection attack detection service. The filtering service 511 interacts with the application connectors and other cybersecurity services based on responses from the prompt injection attack detection service. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase "at least one of' preceding a list with the conjunction "and" should not be treated as an exclusive list and should not be construed as a list of categories with one item from each category, unless specifically stated otherwise. A clause that recites "at least one of A, B, and C" can be infringed with only one of the listed items, multiple of the listed items, and one or more of the items in the list and another item not listed.

1. A method comprising:
detecting application layer messages communicated between a first software-as-a- service (SaaS) application and a plurality of applications integrated with the SaaS application;
associating metadata with each of the application layer messages, wherein the metadata comprise an identifier of a corresponding one of the plurality of applications and a source attribute;
for each of the application layer messages,
determining a risk score for the one of the plurality of applications identified by the identifier associated with the application layer message; and
filtering out the application layer message from being submitted to a prompt injection attack detection service based, at least partly, on the risk score of the application identified by the identifier and the source attribute.

2. The method of claim 1 further comprising blocking the application layer message if not filtered out and the prompt injection attack detection service responds that an indirect prompt injection attack was detected.

3. The method of claim 2 further comprising, if the prompt injection attack detection service responds that an indirect prompt injection attack was detected, submitting the application layer message for additional security analysis and remediating at least an interaction between the identified application and the first SaaS application based on the detected prompt injection attack.

4. The method of claim 1, wherein filtering out the application layer message comprises filtering out the application layer message if the risk score of the identified application does not satisfy a defined risk threshold and/or the source attribute indicates that the application layer message is from an external user.

5. The method of claim 1, wherein an external user is external with respect to a tenant associated with the first SaaS application.

6. The method of claim 1, wherein the application layer messages are request and response messages according to an application programming interface (API) of the first SaaS application and APIs of the plurality of applications.

7. The method of claim 1, wherein the metadata also comprises a tenant identifier and the filtering is also based on the tenant identifier.

8. The method of claim 1 further comprising periodically caching risk scores of applications from one or more risk scoring services.

9. A non-transitory, machine-readable medium having program code stored thereon,
the program code comprising instructions to:
based on receipt of a query request from one of a plurality of application connectors, update a tracking structure to track state of the query request, wherein the query request comprises application programming interface (API) traffic data and descriptors;
determine a risk score for an application identified by a first of the descriptors;
determine whether the risk score for the application identified by the first descriptor satisfied a defined risk threshold;
based, at least partly, on a determination that the risk score satisfies the defined risk threshold, query a prompt injection attack detection service with the API traffic data;
based, at least partly, on a determination that the risk score does not satisfy the defined risk threshold, filter out the query request; and
respond to the query request based on either a verdict from the prompt injection attack detection service or the filtering out.

10. The non-transitory, machine-readable medium of claim 9, wherein the instructions to respond to the query request based on the filtering out comprise
instructions to respond to the application connector indicating that a prompt injection attack was not detected or to allow a request corresponding to the API traffic data.

11. The non-transitory, machine-readable medium of claim 9, wherein the instructions to respond to the query request based on a verdict comprise instructions to, if the prompt injection attack detection service responds that an indirect prompt injection attack was detected, submit the API traffic data to another cybersecurity service for additional security analysis and, if the prompt injection attack detection service responds that a prompt injection attack was not detected, respond to the query request to allow a corresponding API request.

12. The non-transitory, machine-readable medium of claim 9, wherein the program code further has stored thereon instructions to evaluate a second of the descriptors according to a cybersecurity policy and to filter the query request based, at least partly, on the evaluation.

13. The non-transitory, machine-readable medium of claim 12, wherein the instructions to evaluate the second of the descriptors according to a cybersecurity policy and to filter the query request based on the evaluation comprise instructions to determine whether the second descriptor indicates an external source or an internal source and to filter out the query request if the second descriptor indicates an internal source, wherein the cybersecurity policy indicates that internal sources can be filtered out.

14. The non-transitory, machine-readable medium of claim 9, wherein the program code further has stored thereon instructions to periodically cache risk scores of applications from one or more risk scoring services.

15. The non-transitory, machine-readable medium of claim 9, wherein the program code further comprises application connector instructions to decorate an API request for a Software-as-a-Service (SaaS) integration that includes at least one foundation
model based SaaS application with the descriptors and to form a query request with API traffic data of the API request and the descriptors.

16. A system comprising:
a first processor; and
a first machine-readable medium having filtering service instructions stored thereon that are executable by the first processor to cause a first apparatus to,
based on receipt of a query request from one of a plurality of application connectors, update a tracking structure to track state of the query request, wherein the query request comprises application programming interface (API) traffic data and descriptors;
determine a risk score for an application identified by a first of the descriptors;
determine whether the risk score for the application identified by the first descriptor satisfied a defined risk threshold;
based, at least partly, on a determination that the risk score satisfies the defined risk threshold, query a prompt injection attack detection service with the API traffic data;
based, at least partly, on a determination that the risk score does not satisfy the defined risk threshold, filter out the query request; and
respond to the query request based on either a verdict from the prompt injection attack detection service or the filtering out.

17. The system of claim 16, wherein the instructions to filter out the query request comprise instructions executable by the first processor to cause the first apparatus to respond to the application connector indicating that a prompt injection attack was not detected or to allow a request corresponding to the API traffic data.

18. The system of claim 16, wherein the instructions to respond to the query request based on a verdict comprise instructions executable by the first processor to cause the first apparatus to, if the prompt injection attack detection service responds that an indirect prompt injection attack was detected, submit the API traffic data to another cybersecurity service for additional security analysis and, if the prompt injection attack detection service responds that a prompt injection attack was not detected, respond to the query request to allow a corresponding API request.

19. The system of claim 16, wherein the filtering service instructions further comprise instructions to:
evaluate a second of the descriptors according to a cybersecurity policy;
determine whether the second descriptor indicates an external source or an internal source; and
filter out the query request if the second descriptor indicates an internal source, wherein the cybersecurity policy indicates that internal sources can be filtered out.

20. The system of claim 16 further comprising:
a second processor; and
a second machine-readable medium having application connector service instructions stored thereon that are executable by the second processor to cause a second apparatus to decorate an API request for a Software-as-a- Service (SaaS) integration that includes at least one foundation model based SaaS application with the descriptors and to form a query request with API traffic data of the API request and the descriptors.
